(19) United States
(12) Patent Application Publication
(10) Pub. No.: US 2015/0285445 A1
(43) Pub. Date: Oct. 8, 2015

(54) Window Glow Device

(71) Applicant: Crayola LLC, Easton, PA (US)

(72) Inventor: Craig Skinner, Easton, PA (US)

(21) Appl. No.: 14/680,535

(22) Filed: Apr. 7, 2015

Related U.S. Application Data
(60) Provisional application No. 61/976,263, filed on Apr. 7, 2014.

(51) Int. Cl. F21K 99/00; F21V 23/00; F21V 21/092; F21V 33/00

(52) U.S. Cl. CPC F21K 9/56; F21V 33/0028; F21V 23/003; F21V 21/092; F21Y 2101/02

(57) ABSTRACT

Embodiments of the invention are directed to a method and device for creating and applying artwork on windows and window-like substrates that fluoresces or “glows” when illuminated by LEDs. The illumination device causes markings on the window surface to glow based on an arrangement of LEDs in a housing of the device. The device further includes a control component associated with the arrangement of LEDs for turning the device on and off. An attachment component of the device is used to position the arrangement of LEDs with respect to a glass surface, such as a window, for illuminating fluorescent markings made by a user.

### CROSS-REFERENCE TO RELATED APPLICATIONS

This application claims priority to U.S. Provisional Patent Application No. 61/976,263, filed Apr. 7, 2014, entitled “Window Glow Device,” having Attorney Docket Number HALC.153514, the entire contents of which is hereby incorporated by reference.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

In brief and at a high level, this disclosure describes, among other things, embodiments of a window illuminating and/or window glow device that enables a user to create and apply artwork on windows and window-like substrates and/or surfaces. In embodiments of the invention, the artwork applied to such substrates/surfaces is configured to fluoresce and/or “glow” when illuminated by light emitting diodes (LEDs), such as light emitted from one or more LEDs coupled to a window illuminating device.

Further embodiments of the invention are directed to a kit that includes the window illuminating device, one or more window clings, and/or one or more window markers, crayons, and/or paints for applying markings to the window that glow upon illumination by the LEDs of embodiments of the window illuminating device.

### DESCRIPTION OF THE DRAWINGS

Illustrative embodiments of the invention are described in detail below with reference to the attached drawing figures, and wherein:

FIG. 1 includes front and perspective views of a window illuminating kit, in accordance with an embodiment of the invention;

FIG. 2 is a top view of a window illuminating device, in accordance with an embodiment of the invention;

FIG. 3 is a front view of the window illuminating device of FIG. 2, in accordance with an embodiment of the invention;

FIG. 4 is a top view of the window illuminating device of FIG. 2, with LEDs illuminated, in accordance with an embodiment of the invention; and

FIG. 5 is a top, perspective view of the window illuminating device of FIG. 4, with LEDs illuminated, in accordance with an embodiment of the invention.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include, among other things, a window glow device and/or window illuminating device that directs the output of LEDs upon a smooth transparent surface such as a window, the surface of which being covered with artwork. In one embodiment, the device includes a housing, an arrangement of LEDs, a control component (e.g., an on/off switch, a control circuit to control said LEDs, etc.), a power source, and an attachment/securing component that removably couples the device to a window or other smooth surface (e.g., a transparent window surface). In some embodiments of the invention, the window illuminating device is configured to illuminate one or more markings on a surface exposed to a particular level of environment lighting, such as markings made in an environment having reduced natural lighting, such as markings on a window at night. As such, markings that were previously not illuminated and/or readily visible on a particular surface and/or markings that did not fluoresce or glow at a significant level of strength compared to markings made in a different lighting environment (i.e., markings made at night vs. markings made during the day), may be further illuminated in associated with the window illuminating device, according to embodiments of the invention.

In another aspect, artwork applied to a particular surface may become activated and/or illuminated using the window illuminating device, providing an enhanced visibility compared to a corresponding amount of environment lighting. For example, a user may mark on a window surface with a crayon configured to illuminate using the window illuminating device. Prior to illumination, such crayon markings may be minimally visible to the human eye and/or may not stand out against the window surface. Upon activation/illumination by the LEDs of the window illuminating device, such previously muted markings may have an enhanced appearance that, when viewed by the user, appears to glow.

In one embodiment of the invention, markings generated for illumination by the window illuminating device may be made using a variety of marking formulations configured to luminesce or glow. The user artwork may be applied using markers, crayons, paint brushes, sponges, and any other appropriate method of application for generating a target artwork for illumination by the LEDs of the window illuminating device. For example, a method of application of a fluorescent marking material may produce artwork having colorants configured to fluoresce or glow when illuminated with the appropriate wavelength of light. Examples of such markers, crayons, and/or paints include Crayola® Window Markers, Window Crayons, and Window Paints, available from Crayola® LLC, Easton, Pa.

Embodiments of the invention also include artwork that is either pre-drawn or printed on a thin clear plastic “cling” and/or decal that adheres to the smooth glass surface. In further embodiments, the artwork on such “clings” may contain colorants that fluoresce when illuminated by the appropriate wavelength of light, such as LED light emitted from a window illuminating device. Alternatively, in further embodiments, blank clings may be provided, which may then be decorated by the user with a desired art material and coupled to a smooth surface, such as a window. As such, in one embodiment, a window illuminating device may illuminate artwork directly applied to a window (i.e., drawn onto the window surface) or indirectly applied to a window (i.e., drawn on the surface via a window cling applied to the surface of the window).

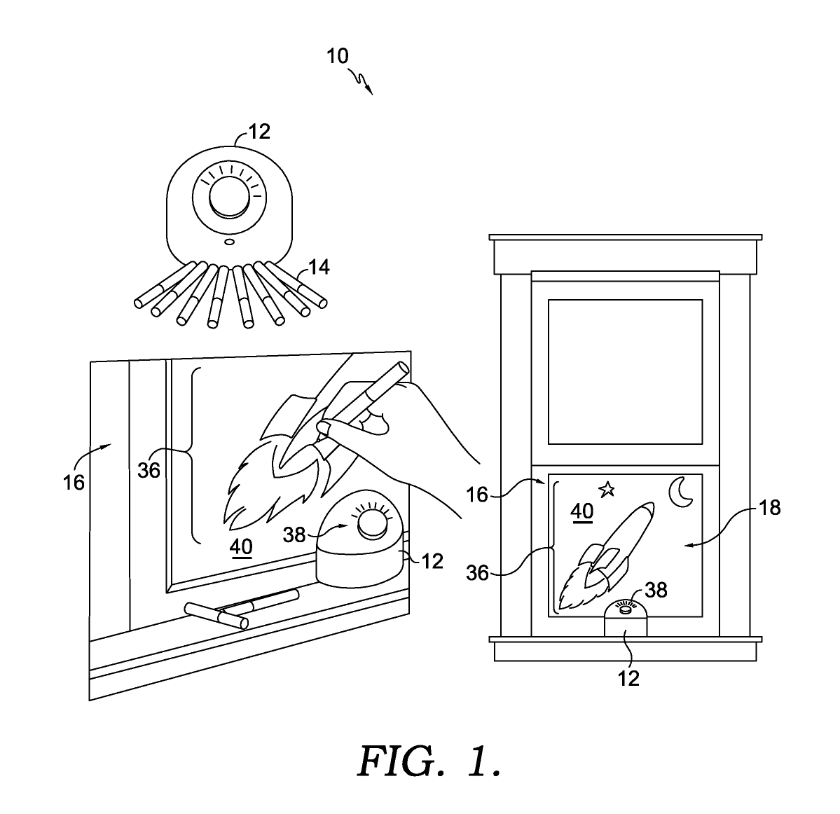

Additional embodiments of the invention are directed to a kit that includes the window illuminating device, window clings, and special window markers, crayons, and/or paints for applying markings to the window (either directly via contact with the window surface or indirectly via application of an intermediary cling), which glow upon illumination by the LEDs. As will be understood, the window illumination kit may include any number of window illuminating devices, window clings and/or marking devices. For example, as shown in the window illuminating kit 10 of FIG. 1, the window illuminating device 12 may be provided with corresponding marking devices 14 configured to mark on the window surface 16. Upon generation of such markings, the illuminated artwork 18 may be generated based on activating one or more LEDs of the window illuminating device 12 to provide emitted light 38.

As further shown in FIG. 1, the emitted light 38 from the window illuminating device 12 may be focused on and/or directed towards a particular portion of the window surface 16. In one embodiment, a target portion 36 of a surface/substrate 40 includes an area of the window surface 16 within a particular range of illumination from the window illuminating device 12. In short, one or more features of the window illuminating device 12 may be configured to direct and/or focus the emitted light 38 towards a particular portion of the window surface 16, such as the target portion 36 of the surface/substrate 40. In further embodiments, the surface/substrate 40 may include a glass surface of a window, while in another embedment, the surface/substrate 40 may be any additional surface configured to receive markings from one or more marking devices 14 to provide illuminated artwork 18.

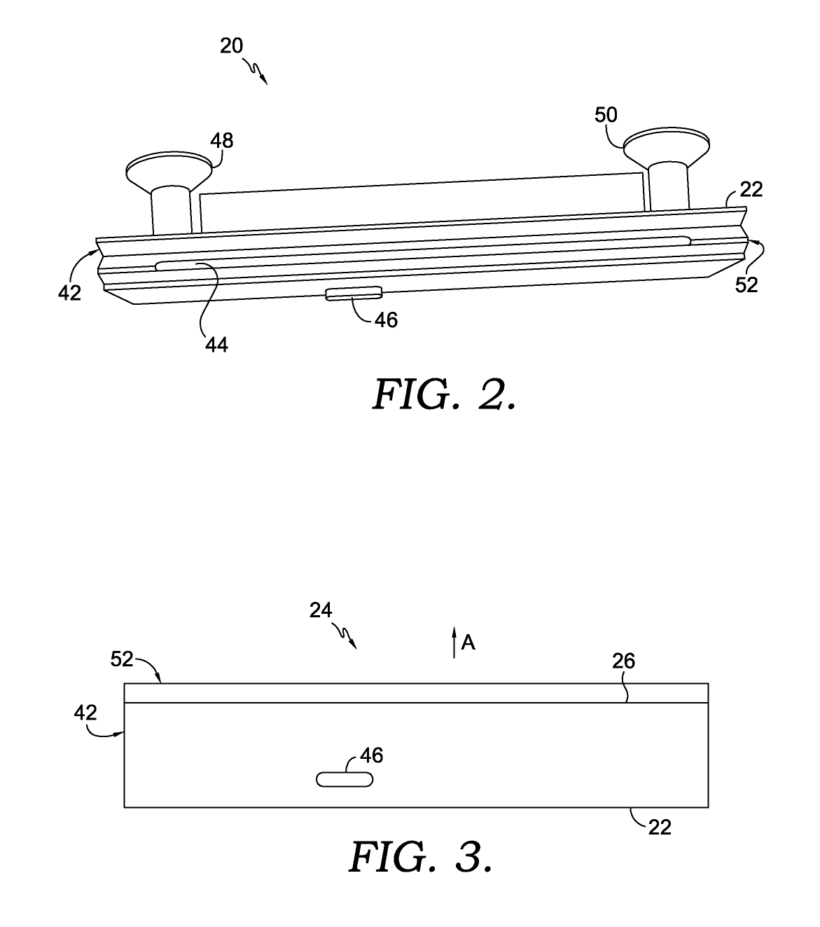

In embodiments of the invention, a window illuminating device may be any device configured to illuminate at least one surface adjacent to and/or coupled to the window illuminating device. In one embodiment, as shown in the top view 20 of FIG. 2, a window illuminating device 22 may include a housing 42 having one or more lighting components 44 (e.g., LEDs) on an upper end 52 of the housing 42, a control component 46 for turning the lighting components 44 on and off (e.g., a power switch), and one or more attachment mechanisms 48 and 50 for coupling the window illuminating device 22 to a surface and/or substrate. As such, in one embodiment, the attachment mechanisms 48 and 50 of the window illuminating device 22 may include one or more suctions for coupling the window illuminating device 22 to a window surface. In one aspect, the window illuminating device 22 may be coupled to a bottom edge of a window frame such that the LEDs within the housing are positioned to project light towards the window glass surface. Similarly, the window illuminating device 22 may be coupled to a particular portion of a window glass, such as a lower portion of the window glass, such that the illuminating LEDs within the housing are directed towards a particular portion of the window surface (e.g., an upper portion opposite the lower portion from which the light is directed).

Further, as shown in the front view 24 of FIG. 3, a window illuminating device 26 may include a front surface of the housing 42 that encloses at least a portion of the window illuminating device 22. As such, one or more features of the housing 42 may be configured to direct light from the lighting component(s) 44 (LEDs) towards a particular surface, such as a substrate to which the window illuminating device 26 is attached, with the top surface 52 facing in an upward direction A.

The attachment mechanism for removably coupling the window illuminating device to a substrate may include any attachment component/mechanism for coupling the window illuminating device 26 at a particular position with respect to the substrate. In one aspect, the attachment component is a pair of suctions configured to secure first and second ends of the device. In another aspect, the attachment component is configured to removably couple the window illuminating device 26 to a particular substrate surface, such as a suction, latch, adhesive strip, etc., for attaching to a particular substrate/surface, such as an adhesive configured to removably couple the illuminating device 26 to a window glass surface. In one aspect, the window illuminating device 26 may include multiple different attachment mechanisms/components for selectively coupling to a variety of surfaces at a particular distance between the surface/substrate and the window illuminating device 26. As such, an example of the window illuminating device 26 may include a first attachment mechanism for coupling to a glass surface and a second attachment mechanism for coupling to a wooden surface. Further, such attachment mechanisms may secure the body of the housing at a particular position with respect to the surface/substrate receiving light emitted by the window illuminating device 26. For example, the housing of the window illuminating device 26 may be positioned parallel to the window surface such that one or more LEDs within the housing are directed at a particular angle towards the window surface, such as directing LEDs at a 45-degree angle towards the window surface.

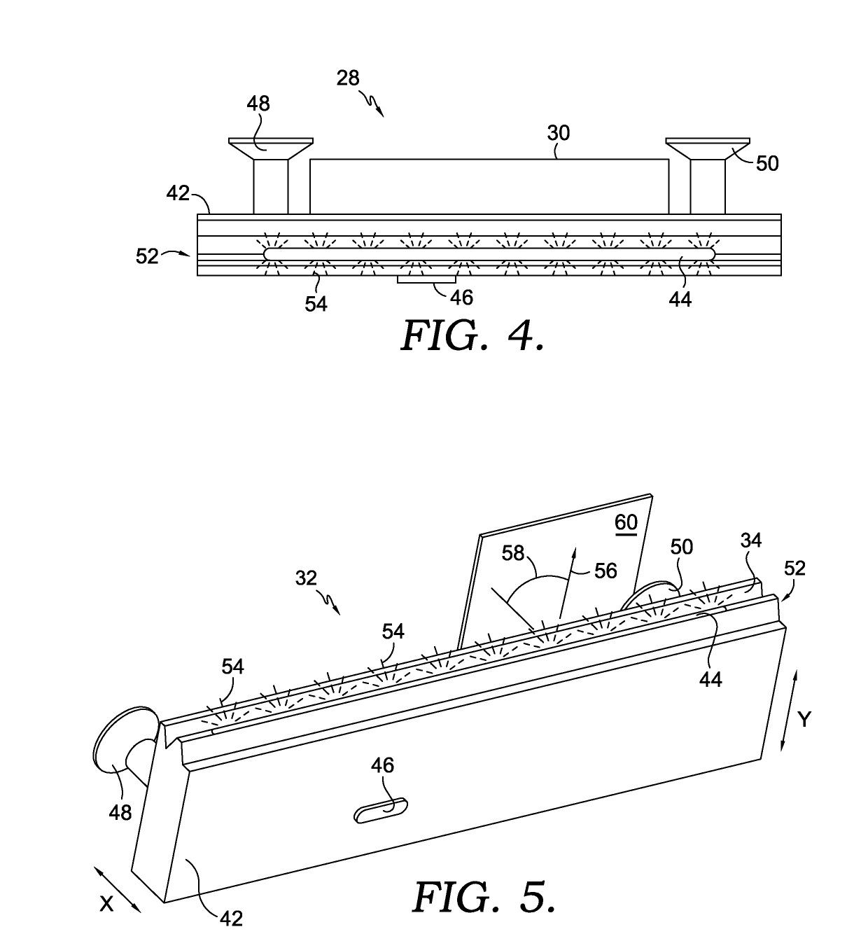

Turning now to FIG. 4, the top view 28 of a window illuminating device 30 depicts multiple LEDs of a lighting component 44 illuminated, according to one embodiment of the invention. As such, in the embodiment of FIG. 4, a top surface 52 of the window illuminating device 30 may direct emitted light 54 from the LEDs in at least a first direction, such as towards a surface of a window. In one aspect, the top surface 52 of the window illuminating device 30 may include one or more apertures and/or openings for allowing light emitted from LEDs positioned inside the housing 42 to provide emitted light 54 that contacts a particular surface/substrate, such as a window surface adjacent the housing 42 of the window illuminating device 30. In another aspect, a top surface 52 of the window illuminating device 30 may include one or more rows of parallel lighting components 44 and/or lighting features, such as one or more rows of LED lighting strips, directed to a common surface such as the window surface coupled to the window illuminating device 30. Accordingly, a first LED lighting strip may be directed to a first portion of the target surface, while a second LED lighting strip may be directed to a second portion of the target surface. In some aspects, a target surface includes one or more portions of a substrate/surface for receiving drawing markings from a user and providing an illuminated drawing surface in association with the window illuminating device 30. In some embodiments of the invention, a window illuminating device 30 is coupled to a target surface that receives one or more user markings (e.g., markings done in a marking medium configured to fluoresce/glow upon illumination), having a first appearance without illumination by the window illuminating device 30, and a second appearance upon illumination with one or more of the window illuminating device 30 LEDs.

Further, as shown in the embodiment of FIG. 5, a top, perspective view 32 of a window illuminating device 34 depicts an orientation of the lighting component 44 LEDs housed by the window illuminating device 34, along a body of the window illuminating device 34. In the example of FIG. 5, the window illuminating device In some embodiments of the invention, based on coupling of the body of the window illuminating device 34 to at least a portion of a window surface, one or more LEDs illuminated within the window illuminating device 34 may project an amount of light (emitted light 54) onto a particular surface/substrate 60 for illuminating one or more user markings generated for interaction with the window illuminating device 34. In the example of FIG. 5, at least a portion of the emitted light 54 includes directed light 56 that is emitted at a particular angle 58 towards the surface/substrate 60. As such, based on a position of one or more lighting components 44 within the housing 42 of the window illuminating device 34, and a corresponding angle 58 of light emission with respect to the window illuminating device 42, the user-generated artwork within a particular target portion 36 receiving the directed light 56 may become illuminated.

In one embodiment, the window illuminating device 34 is oriented along a central, longitudinal axis having a first end and a second end. The first end of the window illuminating device 34 may include a first end attachment mechanism 48 while the second end of the window illuminating device 34 may include a second attachment mechanism 50. As such, at least two attachment points between the window illuminating device 34 and a window surface (such as glass) and prevent rotation or shifting while lighting the user's artwork on the target surface/substrate 60.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for creating glowing artwork, wherein the method comprises:
generating at least one marking on a glass surface, the at least one marking generated using one or more of specialty inks, crayons, and paints; and
illuminating said at least one marking with light from a light source, said light from a light source comprising light generated with one or more light-emitting diodes (LEDs) having a spectral output that causes fluorescence of the at least one marking.

2. The method of claim 1, wherein the glass surface is transparent.

3. The method of claim 1, wherein each of the specialty inks, crayons and paints is configured for application to the glass surface.

4. The method of claim 1, wherein the light source comprises a plurality of LEDs coupled to the light source in a particular orientation for illuminating the at least one marking.

5. The method of claim 4, wherein the particular orientation comprises a first LED in a first position with respect to the glass surface.

6. The method of claim 5, wherein the particular orientation comprises a second LED in a second position with respect to the glass surface.

7. A device for illuminating and causing markings to glow on a window surface, the device comprising:
a housing;
an arrangement of LEDs;
one or more control components associated with the arrangement of LEDs;
a power source; and
at least one attachment component for securing said device to a glass surface.

8. The device of claim 7, wherein the one or more control components comprises a circuitry configured to control the LEDs.

9. The device of claim 7, wherein the one or more control components comprises a switch configured to turn power to the device on and off.

10. The device of claim 9, wherein the switch is an automatic switch operable in response to contact with the glass surface.

11. The device of claim 7 wherein the at least one attachment component comprises a plurality of suctions for removably coupling the device to the glass surface.

12. A kit for creating glowing window artwork, the kit comprising:
one or more surface marking components configured to mark on a glass surface to provide window artwork; and
a device for illuminating and causing said window artwork to fluoresce, the device comprising a housing, an arrangement of LEDs, a power source, and an attachment component for securing said device to the glass surface.

13. The kit of claim 12, wherein the one or more surface marking components comprises one or more of a specialty ink, marker, crayon, powder, decal, and paint.

14. The kit of claim 13, wherein one or more markings applied by one or more of the specialty ink, marker, crayon, powder, decal, and paint is configured to fluoresce upon illumination by the device.

15. The kit of claim 12, wherein the device further comprises a control component configured to turn the arrangement of LEDs on or off.

16. The kit of claim 12, wherein the attachment component comprises a plurality of suction features for removably coupling the device to the glass surface.

17. The kit of claim 16, wherein the plurality of suction features comprise a first suction on a first end of the device and a second suction on a second end of the device.

18. The kit of claim 13, wherein the attachment component is configured to removably secure the device at a particular distance from the glass surface such that light emitted from the arrangement of LEDs contacts the glass surface at a particular angle.

19. The kit of claim 18, wherein contacting the glass surface at a particular angle comprises contacting an area of the glass surface comprising one or more markings from the one or more surface marking components.

20. The kit of claim 13, wherein the attachment component is configured to removably secure the device at a particular position with respect to the glass surface such that a first LED of the arrangement of LEDs is directed toward the glass surface at a first angle with respect to the housing, and a second LED of the arrangement of LEDs is directed toward the glass surface at a second angle with respect to the housing.
